(19) United States
(12) Patent Application Publication
(10) Pub. No.: US 2026/0369900 A1
(43) Pub. Date: Nov. 19, 2026

(54) CONNECTION TERMINAL FOR CONNECTING AN ELECTRICAL WIRE

(71) Applicant: PHOENIX CONTACT GMBH & CO. KG, Blomberg (DE)

(72) Inventors: Dennis GEISLER, Extertal (DE); Klaus Begemann, Schieder- Schwalenberg (DE); Sebastian Schäfer, Blomberg (DE)

(21) Appl. No.: 18/995,943

(22) PCT Filed: Jul. 12, 2023
(86) PCT No.: PCT/EP2023/069305

§ 371 Date: Jan. 17, 2025

(30) Foreign Application Priority Data
Jul. 21, 2022 (LU) 502540

(51) Int. Cl. H01R 4/48; H01R 9/24

(52) U.S. Cl. CPC H01R 4/483; H01R 4/4821; H01R 4/4835; H01R 4/48365; H01R 9/2491

(57) ABSTRACT

A connection terminal for connecting an electrical wire includes: a housing having an insertion opening into which the electrical wire is insertable for connection to the connection terminal; a contact element arranged on the housing for electrically contacting the electrical wire; a spring element arranged on the housing, the spring element having a clamping portion for interacting with the electrical wire to bring the electrical wire into contact with the contact element; an actuation element pivotally arranged on the housing and movable from a non-actuated position into an actuated position so as to move the clamping portion; a release element having a supporting end and a release portion elastically movable relative to the supporting end; and a connecting device to which the support end is attached. The actuation element engages the release element when in the actuated position so as to hold the actuation element in the actuated position.

### CROSS-REFERENCE TO PRIOR APPLICATIONS

This application is a U.S. National Phase application under 35 U.S.C. § 371 of International Application No. PCT/EP2023/069305, filed on Jul. 12, 2023, and claims benefit to Luxembourg Patent Application No. LU 502540, filed on Jul. 21, 2022. The International Application was published in German on Jan. 25, 2024 as WO/2024/017732 under PCT Article 21(2).

### FIELD

The invention relates to a connection terminal for connecting an electrical wire.

### BACKGROUND

Such a connection terminal comprises a housing which has an insertion opening into which the electrical wire can be inserted for connection to the connection terminal. A contact element for electrically contacting the electrical wire is arranged on the housing. A spring element is also arranged on the housing, which comprises a clamping portion that is designed to act on the electrical wire in order to bring the electrical wire into contact with the contact element when the electrical wire is inserted into the insertion opening. An actuation element can be actuated by a user in order to move the clamping portion. For this purpose, the actuation element can be moved from a non-actuated position to an actuated position, for example using a tool so that, in the actuated position, the clamping portion is moved, for example to facilitate insertion of the electrical wire into the insertion opening or to remove the electrical wire from the insertion opening.

By using the spring element, such a connection terminal establishes a spring force connection in which, in the connected position, the electrical wire is clamped to the contact element under the elastic action of the spring element and is thus electrically connected to the contact element.

In a connection terminal known from DE 10 2019 127 464 B3, a spring element in the form of a tension spring is provided, which pulls a connected electrical wire into abutment with an associated contact element by the resilient action of the spring and thus establishes a clamping connection between the electrical wire and the contact element. For this purpose, when attaching the electrical wire, it is pushed through an opening in the clamping portion and is clamped between the clamping portion and the contact element when in the connected position.

The connection terminal in DE 10 2019 127 464 B3 provides a locking device used to lock the clamping portion relative to the housing in a release position. When the electrical wire is inserted, the locking device is released and the locking engagement is therefore released such that the clamping portion is moved from the release position and the electrical wire is thereby clamped to the contact element. In order to move the clamping portion into the release position, in particular to enable the electrical wire to be attached or to release a connected electrical wire from the connection terminal, a tool, for example a screwdriver, can be attached to the connection terminal, and a force can thereby be exerted on the clamping portion.

While in DE 10 2019 127 464 B3 the clamping portion is directly moved by means of a tool, in each of the connection terminals known from DE 10 2019 135 203 A1 and DE 10 2020 104 140 A1, an actuation element in the form of a so-called pusher is provided which can be pushed into the housing of the connection terminal in order to thereby act on the clamping portion and to transfer the clamping portion into its release position. The actuation element is spring-loaded relative to the housing of the connection terminal via a clamping spring in the form of a compression spring. In the connection terminal known from DE 10 2019 135 203 A1, an actuating lug is arranged on the actuation element which hooks into a fastening portion of a retaining element when the actuation element is in the actuated position.

### SUMMARY

In an embodiment, the present invention provides a connection terminal for connecting an electrical wire, comprising: a housing having an insertion opening into which the electrical wire is insertable for connection to the connection terminal; a contact element arranged on the housing, the contact element being configured to electrically contact the electrical wire; a spring element arranged on the housing, the spring element having a clamping portion configured to interact with the electrical wire to bring the electrical wire into contact with the contact element; an actuation element pivotally arranged on the housing and movable from a non-actuated position into an actuated position so as to move the clamping portion; a release element having a supporting end and a release portion elastically movable relative to the supporting end; and a connecting device to which the support end is attached, wherein the actuation element is configured to engage the release element when in the actuated position so as to hold the actuation element in the actuated position, wherein the release portion is configured to interact with the electrical wire when the electrical wire is inserted into the insertion opening so as to release the actuation element from the actuated position.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a view of a connection arrangement with a plurality of connection terminals accommodated in a housing;

FIG. 2 is a view of the connection arrangement from the front;

FIG. 3 is a sectional view of a connection terminal along line A-A according to FIG. 2, with the actuation element in a non-actuated position;

FIG. 4A is a view of a housing part of a connection terminal;

FIG. 4B is a view of a housing part of an adjacent connection terminal;

FIG. 5A-5C are separate views of a release element of the connection terminal;

FIG. 6A is a view of a housing part of the connection terminal;

FIG. 6B is an enlarged view of detail X according to FIG. 6A;

FIG. 7A is another view of the housing part of the connection terminal;

FIG. 7B is an enlarged view of detail X according to FIG. 7A; and

FIG. 8 is a sectional view along line B-B according to FIG. 1.

### DETAILED DESCRIPTION

In an embodiment, the present invention provides a connection terminal which makes it possible in a simple manner to hold the clamping portion of the spring element in a release position and to transfer it into a clamping position when an electrical wire is inserted.

Accordingly, the connection terminal comprises a release element which has a supporting end and a release portion which is elastically movable relative to the supporting end. The housing has a connecting device to which the supporting end is fastened. The actuation element is designed to engage with the release element in the actuated position so that the actuation element is held in the actuated position. The release portion is designed to interact with the electrical wire when said wire is inserted into the insertion opening to release the actuation element from the actuated position.

The electrical wire in the connection terminal is electrically contacted by the electrical contact element by the clamping portion acting on the electrical wire when said electrical wire is inserted into the insertion opening and applying an elastic load thereto in the direction of contact with the contact element. To make it easier to attach the electrical wire, the clamping portion of the spring element can be elastically deflected by actuating the actuation element in order to thereby move the clamping portion into a release position in which a space in the region of the insertion opening is cleared, and the electrical wire can accordingly be inserted into the insertion opening substantially without any force, or a connected electrical wire can (alternatively) be easily removed from the connection terminal. The actuation element can, for example, be designed as a pusher and can be pushed into the housing by user actuation while pivoting relative to the housing in order to thereby act on the clamping portion and to move the clamping portion in the direction of the release position.

In the actuated position, the actuation element, which is pivotally mounted on the housing, engages with a release element which is supported on the housing via a supporting end. The release element is directly fastened to the housing via the supporting end by the supporting end being operatively connected to a connecting device of the housing and is thereby held on the housing in a torque-tight manner.

In the actuated position, the actuation element is accordingly held in position by the release element such that the clamping portion of the spring element is thereby also held in its release position in which it is possible to easily attach an electrical wire to the connection terminal or to remove a connected wire from the connection terminal substantially without any force.

The release element is used to engage with the actuation element in the actuated position. By actuating the actuation element, the clamping portion can accordingly be moved relative to the housing and transferred into a release position such that in particular it is possible to easily insert an electrical wire into the insertion opening in the housing in order to connect the wire to the connection terminal. In so doing, the release element also serves to release the actuation element from the actuated position in order to automatically release the actuation element from the actuated position when the electrical wire is inserted into the insertion opening and thus to transfer the clamping portion into a clamping position in which the electrical wire inserted into the insertion opening is electrically contacted by the contact element of the connection terminal. For this purpose, the release element comprises a release portion which is designed to interact with the electrical wire when inserted into the insertion opening. By interacting with the electrical wire, the release portion is released and therefore the locking engagement between the actuation element and the release element is undone, and the actuation element is thus released from the actuated position.

After undoing the locking engagement, the actuation element can move back, in particular automatically, toward the non-actuated position, preferably under spring preload. The actuation element can be subjected to spring preload in particular by the clamping portion which is elastically deflected in the actuated position and, after the actuation element has been released, acts on the actuation element in a resiliently mechanical manner to transfer the actuation element from the actuated position toward the non-actuated position.

Since the release portion of the release element is deflected when the electrical wire is inserted, the connection terminal closes automatically when the electrical wire is inserted. This results in a simple connection process, with reliable contact between the electrical wire and the contact element as a result of the clamping effect of the clamping portion.

The supporting end is fixed to the connection device of the housing in a torque-proof manner. The supporting end can extend flat, which has the advantage that a contour can be formed at the supporting end in a simple manner, for example by punching, via which contour it can be reliably, for example interlockingly, fixed to the connecting device of the housing.

In one embodiment, the housing defines a receiving space into which the electrical wire can be introduced by inserting it into the insertion opening. The release portion extends into the receiving space to interact with the electrical wire. In particular, the electrical wire can be inserted into the insertion opening along an insertion direction, wherein the release portion extends transversely to the insertion direction within the receiving space. The release portion can be elastically deflected relative to the supporting portion of the release element so that the release portion is elastically adjusted when interacting with the electrical wire.

While the supporting end is supported in a torque-tight manner relative to the housing, the release portion can be elastically moved in the receiving space and extends in the receiving space in such a way that an electrical wire inserted into the insertion opening strikes the release portion when introduced into the receiving space and thus deflects it.

In one embodiment, the release portion engages, in a locking position, with the actuation element located in the actuated position. The release portion can be moved from the locking position to release the actuation element from the actuated position by interacting with the electrical wire. The actuation element is thus locked in the actuated position via the release portion. By deflecting the release portion from the locking position, the locking engagement can be released such that the actuation element is released from the actuated position, and thus the clamping portion of the spring element can be moved from the release position toward a clamping position.

In one embodiment, the spring element is designed as a tension spring. In this case, the clamping portion of the spring element is designed to pull the electrical wire into abutment with the contact element by spring force. In this case, for example, an opening can be formed in the clamping portion through which the electrical wire can be guided when it is inserted into the insertion opening in the housing in order to pull the electrical wire into clamping contact with the contact element after the clamping portion has been released from the release position.

Alternatively, the spring element can be designed as a compression spring. In this case, the clamping portion is designed to push the electrical wire into abutment with the contact element by spring force. When inserted into the insertion opening, the electrical wire enters a space between the clamping portion and the contact element, wherein, after the clamping portion has been released from the release position, the clamping portion acts on the electrical wire and pushes it into abutment with the contact element.

In one embodiment, the clamping portion is elastically movable relative to the housing into a release position by actuating the actuation element and is held in the release position relative to the housing by the actuation element locked in the actuated position. The clamping portion is thus locked in the release position relative to the housing such that the clamping portion remains in the release position after the actuation of actuation element.

The spring element can, for example, have a supporting portion via which the spring element is supported on the housing and held in position on the housing. The clamping portion can be elastically deflected relative to the supporting portion, wherein, in the release position, the clamping portion is deflected such that the spring element is elastically loaded and the clamping portion is moved out of the release position under elastic pretension after being released from the release position.

In one embodiment, the supporting end has at least one first interlocking element, while the connecting device of the housing comprises at least one second interlocking element. The at least one first interlocking element and the at least one second interlocking element interlockingly engage with one another to fix the supporting end to the housing. This creates an interlocking connection between the supporting end and the housing such that the supporting end is held on the housing in a torque-tight manner. The release portion can be elastically deflected relative to the supporting portion, wherein the supporting end is fixed to the housing in such a way that a torque can be introduced into the housing via the supporting end and is supported on the housing.

One of the form-fitting elements can be formed by a recess, for example. The other form-fitting element is then formed by a projection element which interlockingly engages in the recess to fix the supporting end to the housing. For example, the supporting end may have a recess which engages with an associated form-fitting element in the form of a projection element on the housing. The interlocking engagement is in particular such that the supporting end cannot slide off the housing, but is held on the housing in such a way that when the release portion is elastically deflected, the supporting end remains in position on the housing.

In one embodiment, the actuation element is mounted on the housing so as to be pivotable around a pivot shaft and has an actuating portion for actuation by a user and an active portion for acting on the clamping portion. While the actuating portion is accessible from outside the housing, for example by a user being able to act on the actuating portion using a tool, such as a screwdriver, or alternatively manually, the active portion is operatively connected to the clamping portion of the spring element. By moving the actuation element, a movement force is thus exerted on the clamping portion via the active portion such that, in particular when the actuation element is moved from the non-actuated position into the actuated position, the clamping portion is entrained and is thus moved in the direction of the release position.

In one embodiment, the actuation element has a through-opening through which the spring element passes. The spring element can in particular be formed by a bent plate spring where the clamping portion can be deflected along a movement plane relative to the supporting portion. The spring element extends through the through-opening in the actuation element, for example around the pivot shaft of the actuation element, such that the spring element is supported by means of the supporting portion on the housing on a first side of the actuation element, and the clamping portion protrudes from the actuation element on a remote second side and is moved, together with the actuation element, when the actuation element is moved. This results in an installation space-efficient arrangement of the actuation element and the spring element, with force being effectively introduced into the spring element when the actuation element is transferred from the non-actuated position to the actuated position and also from the spring element into the actuation element when the actuation element is returned from the actuated position as a result of the preload of the spring element.

In one embodiment, the actuation element has a locking portion for engaging with a locking device of the release element when in the actuated position. The locking portion can, for example, be arranged on a side of the actuation element facing away from the actuating portion (with respect to the pivot shaft of the pivotable bearing for the actuation element on the housing), preferably approximately diametrically remote from the actuating portion with respect to the pivot shaft. By means of the locking portion, the actuation element is locked in the actuated position by an associated locking device of the release element such that the actuation element is thereby held in the actuated position, but can be released from the actuated position in a simple and reliable manner by releasing the release portion when the electrical wire is inserted.

The locking device of the release element can be formed, for example, by an opening in which the locking portion of the actuation element, for example formed by a projection, engages when the actuation element is in the actuated position. The actuation element is thus held in its actuated position by the interlocking engagement of the locking portion in the opening in the release element, wherein the engagement can be released by moving the release portion, and the actuation element can thus be released from the actuated position in order to transfer the clamping portion into the release position.

The opening with which the locking portion of the actuation element engages in the actuated position can, for example, be formed in the release portion of the release element. By moving the release portion, the engagement can be released by the release portion being moved relative to the locking portion of the actuation element and thus releasing the locking connection.

In one embodiment, the connection terminal is part of a connection arrangement consisting of a plurality of connection terminals that are arranged in a row in a lined-up direction. The lined-up direction extends transversely to the insertion direction in which an electrical wire is to be attached to the connection terminal.

The connection terminals can abut one another and interact with one another in such a way that the side wall of one connection terminal also provides a side wall for an adjacent, additional connection terminal. A single connection terminal is therefore not closed toward the outside, but is only closed when a plurality of connection terminals are arranged next to each other in a row.

The connection terminals of the arrangement can be identical in design. However, the connection terminals can for example also differ in terms of their dimensions, for example the width in the lined-up direction and the number and/or size of the insertion openings.

The housing of the connection terminal can, for example, be formed by two housing parts attached to one another in the lined-up direction, wherein adjacent connection terminals can jointly use the housing parts. Advantageously, it can be provided that the housing parts jointly hold the supporting end of the release element of the connection terminal in position, wherein the housing parts each have, for example, a connecting device. For this purpose, the supporting end of the release element can be fastened, for example, to the connecting devices of the housing parts. For example, the supporting end can be arranged between side walls of the housing parts that extend in parallel with one another in such a way that the supporting end is interlockingly fixed between the side walls of the two housing parts and, for example, interlockingly engages with the connecting devices of the housing parts. The supporting end is thus held between the housing parts of adjacent connection terminals which are arranged in a row and is also fixed by its supporting end in such a way that the release portion of the release element can be elastically deflected with respect to the supporting end, but the supporting end remains in position and can absorb torques.

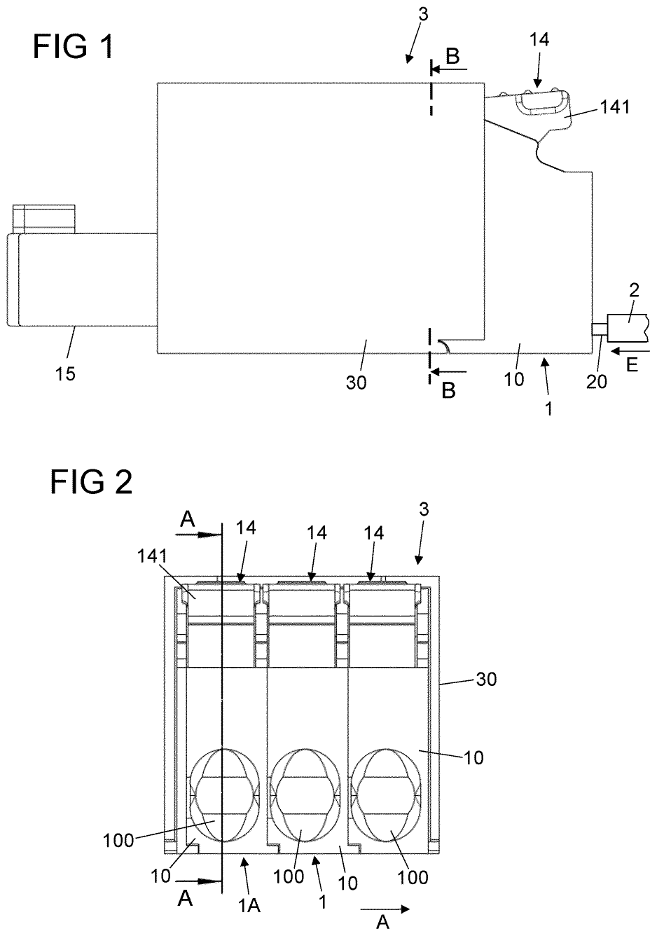

FIGS. 1 and 2 show an embodiment of a connection arrangement 3 which comprises a plurality of connection terminals 1, 1A which are jointly enclosed by an outer housing 30. The connection terminals 1, 1A are arranged in a row in a lined-up direction A and are jointly enclosed by the outer housing 30, wherein each connection terminal 1, 1A is assigned an insertion opening 100 in a housing 10, into which an electrical wire 2 can be inserted in an insertion direction E by means of a (stripped) conductor end 20 in order to connect the electrical wire 2 to the connection terminal 1, 1A.

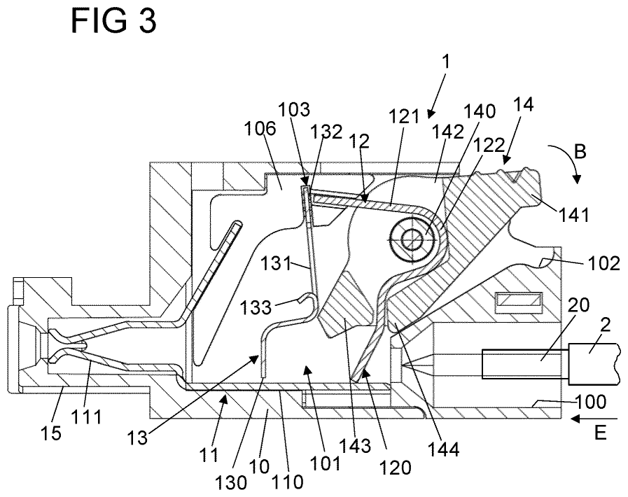

FIG. 3 is a sectional view along line A-A according to FIG. 2 of an embodiment of a connection terminal 1 which has a housing 10 with an insertion opening 100 formed therein for inserting an electrical wire 2 in an insertion direction E.

The housing 10 defines a receiving space 101 into which the electrical wire 2 is introduced by means of a stripped conductor end 20 when it is inserted into the insertion opening 100 in the insertion direction E. In a connected position, the wire 2 with the stripped conductor end 20 is located within the receiving space 101 and is electrically contacted via a clamping portion 120 of a spring element 12 by a contact element 11 in the form of a current bar such that the electrical wire 2 is electrically connected to the connection terminal 1.

The spring element 12 has a supporting portion 121 which is supported on a wall of the housing 10 such that the spring element 12 is fastened to the housing 10 thereby and is fixed to the housing 10. The clamping portion 120 can be elastically deflected relative to the supporting portion 121, in particular such that the clamping portion 120 clamps, in a clamping position, an electrical wire 2 connected to the connection terminal 1 and pushes this under elastic preload into contact with the contact element 11 and thus brings the wire 2 into electrical contact with the contact element 11 via its conductor end 20.

The contact element 11 has a contact portion 110 which extends in the housing 10 in a planar manner and against which the conductor end 20 of the electrical wire 2 is pressed by spring preload of the clamping portion 120 when the electrical wire 2 is connected to the connection terminal 1. The contact portion 110 is connected to a contacting device 111 arranged in a plug connector portion 15, via which contacting device the connection terminal 1 can be plugged into an associated mating electrical connector.

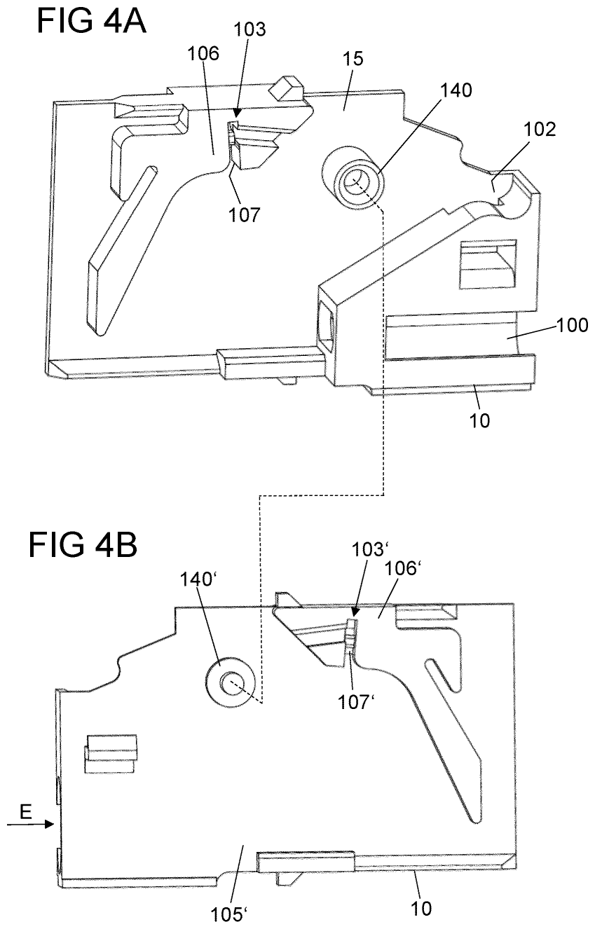

In the illustrated embodiment, the housing 10 of the connection terminal 1 is formed by housing parts 105, 105′ shown in FIGS. 4A and 4B. The adjacent connection terminals 1, 1A jointly use the housing parts 105, 105′. The housing 10 of one connection terminal 1 is thus formed by a housing part 105 and an adjacent housing part 105′ of an adjacent connection terminal 1A.

As can be seen from FIGS. 4A and 4B, the housing parts 105, 105′ of the connecting terminals 1, 1A arranged next to each other in a row are attached to one another and jointly housed in the outer housing 30 of the connection arrangement 3, as can be seen from FIG. 2.

An actuation element 14 is pivotably mounted on the housing 10 of the connection terminal 1 via a pivot shaft 140. The actuation element 14 can be pivoted around the pivot shaft 140 relative to the housing 10, wherein an actuating portion 141 is accessible from outside the housing 10 via an actuating opening 102 and can thus be actuated by a user, for example using a tool.

In the illustrated embodiment, the pivot shaft 140 is formed on the housing part 105 in which a shaft journal 140′ of the housing part 105′ engages and thus completes the pivot bearing for the actuation element 14 on the housing 10, as can be seen from FIGS. 4A and 4B.

The actuation element 14 is operatively connected to the clamping portion 120 of the spring element 12. For this purpose, the spring element 12 passes through a through-opening 142 inside the actuation element 14 such that the spring element 12 grasps around the pivot shaft 140 by means of a curved intermediate portion 122, as can be seen from FIG. 3. The supporting portion 121 protrudes from the opening 142 on a first side and is supported on the housing 10. The clamping portion 120, on the other hand, protrudes from the actuation element 14 on a remote second side and thus extends within the receiving space 101 in the region of the insertion opening 100 in such a way that the spring element 12 can act via the clamping portion 120 on an electrical wire 2 inserted into the insertion opening 100 for contacting the contact element 11 and also for mechanical locking.

The connection terminal 1 has a release element 13 which is fastened to the housing 10 via a supporting end 132 and is thereby supported in a torque-tight manner relative to the housing 10. A release portion 130 extends from the supporting end 132 and projects into the receiving space 101 substantially transversely to the insertion direction E and thus extends in a region aligned with the insertion opening 100.

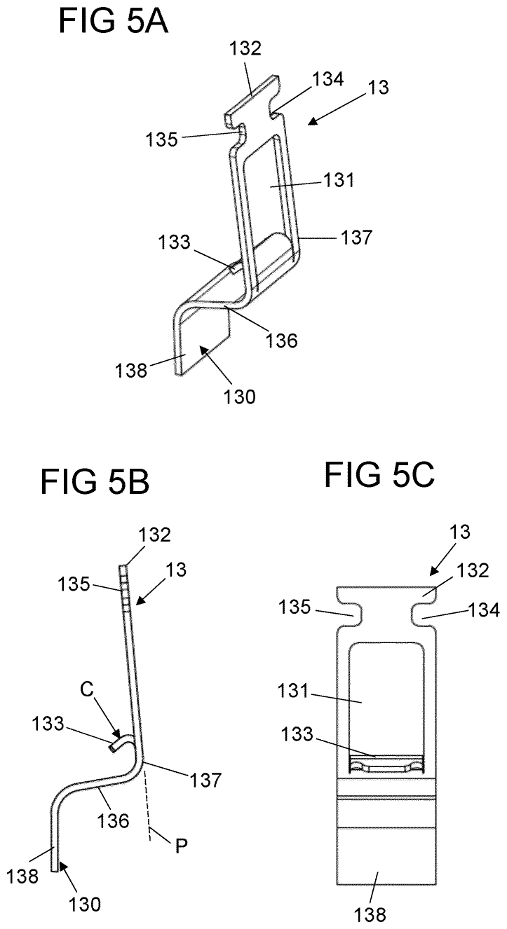

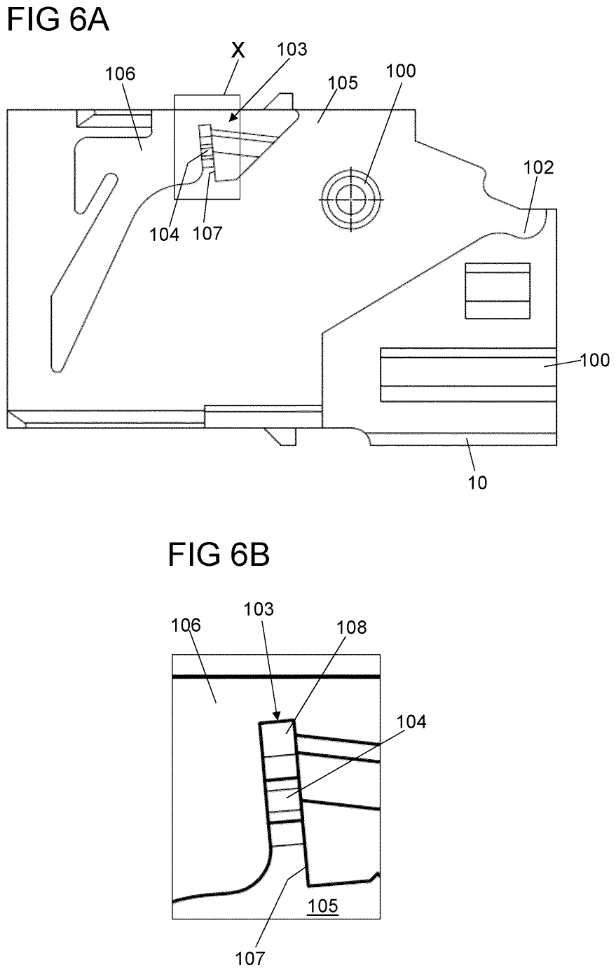

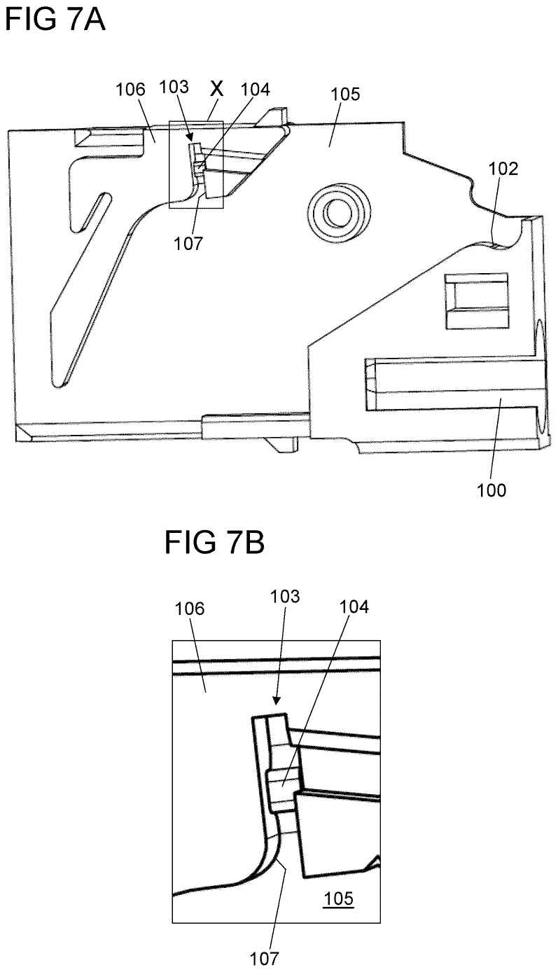

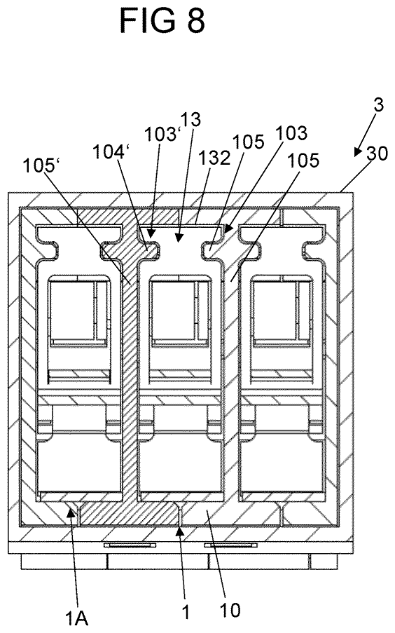

As can be seen from the separate view of the release element 13 according to FIG. 5A-5C, the detailed views of the housing part 105 according to FIGS. 6A, 6B and 7A, 7B and the sectional view according to FIG. 8, the supporting end 132 of the release element 13 is interlockingly connected to connecting devices 103, 103′ of the housing parts 105, 105′ forming the housing 10 of the connection terminal 1. The supporting end 132 of the release element 13 formed by a strip-shaped spring element has recesses 134, 135 in its opposite lateral edges, which, in the mounted position of the release element 13, engage with projection elements 104, 104′ on the connecting devices 103, 103′.

The connecting devices 103, 103′ are each formed by an engagement opening 107, 107′ into which the supporting end 132 engages such that the supporting end 132 is interlockingly received on the housing 10. The supporting end 132 is interlockingly connected to the housing 10 such that the supporting end 132 cannot slide out of the connecting devices 103, 103′ and, in addition, the supporting end 132 is supported on the housing 10 in such a way that, when the release portion 130 is elastically deflected, torques can be absorbed at the supporting end 132 and diverted into the housing 10, and the supporting end 132 thereby remains in position relative to the housing 10.

The engagement opening 107, 107′ is formed in a wall portion 106, 106′ of each housing part 105, 105′, which protrudes from a planar side wall of the housing part 105, 105′, as can be seen from FIGS. 4A and 4B.

As can be seen from the sectional view according to FIG. 8, the supporting end 132 of the connection terminal 1 is received between the housing parts 105, 105′ of the adjacent connection terminals 1, 1A such that the supporting end 132 is interlockingly held on the connecting devices 103, 103′ that mirror each other of the housing parts 105, 105′ of the connection terminals 1, 1A. The housing parts 105, 105′ thus jointly form the housing 10 of the connection terminal 1. The release element 13 is fixed to the connection terminal 1 by the housing 10 and is thus held in position relative to the housing 10 of the connection terminal 1 when the connection terminal 1 is mounted and ready for operation.

The release portion 130 serves to interact with an electrical wire 2 inserted into the insertion opening 100, in particular to automatically connect the electrical wire 2 to the connection terminal 1 by releasing the clamping portion 120.

The release element 13 has an opening 131 with which the actuation element 14 engages via a locking portion 143 in the form of a projection when the actuation element 14 has been transferred into an actuated position in an actuating direction B. In the actuated position, the actuation element 14 engages in the opening 131 by means of the locking portion 143 and is thereby lockingly held on the release portion 130 so that the actuation element 14 is locked in the actuated position.

In the illustrated embodiment, the release portion 130 is bent. Between a free end 138 of the release portion 130 remote from the supporting end 132 and a leg portion 137 of the release portion 130 aligned with the supporting end 132 and in which the opening 131 is formed, an intermediate portion 136 extends transversely between the free end 138 of the release portion 130 and the leg portion 137 of the release portion 130 bearing the opening 131. By suitably shaping the release element 13, the release element 13 can be adapted to the installation space conditions within the receiving space 101 of the housing 10.

If the actuation element 14 is actuated in the actuating direction B and thereby pivoted around the pivot shaft 140 relative to the housing 10, the actuation element 14 entrains the clamping portion 120 of the spring element 12 via an active portion 144 and thereby moves the clamping portion 120 into a release position. In the release position, the free end of the clamping portion 120 is removed from the contact portion 110 of the contact element 11 and thus releases a region within the receiving space 101 aligned with the insertion opening 100 in the insertion direction E such that an electrical wire 2 can be inserted into the insertion opening 100 unhindered by the clamping portion 120 and thus connected to the connection terminal 1 substantially without any force.

If an electrical wire 2 with a stripped conductor end 20 is inserted into the insertion opening 100 and thereby introduced into the receiving space 101 in the insertion direction E while the actuation element 14 is in the actuated position and thus the clamping portion 120 is in the release position, the wire 2 comes into abutment with the release portion 130 of the release element 13 and elastically deflects it relative to the supporting end 132 and thus to the housing 10. As a result, the release portion 130 is moved in the insertion direction E relative to the locking portion 143 of the actuation element 14 so that the locking portion 143 disengages from the opening 131, and thus the actuation element 14 is released from the actuated position.

On a side of the opening 131 facing the free end 138 of the release portion 130, a run-on element 133 is formed by a bent portion of the release element 13 formed as a sheet metal element, against which the locking portion 143 rests in the locking position and onto which the locking portion 143 runs when the locking engagement is released. Since the electrical wire 2 acts on the release portion 130 with a lever arm that is larger than the lever arm acting on the locking portion 143, the release portion 130 can be deflected with little force that is to be applied by the electrical wire 2, and thus the locking engagement can be released easily and reliably when the electrical wire 2 is inserted.

As can be seen from FIG. 3 in conjunction with FIG. 5B, the run-on element 133 is bent in a direction toward the leg portion 137 of the release portion 130 which faces away from the actuation element 14 in the insertion direction E. In the locked position in which the locking portion 143 engages in the opening 131, the locking portion 143 comes to rest at a contact point C on the run-on element 133 that is offset from a plane P along which extends the supporting portion 137 aligned with the supporting end 132. As a result, when the actuation element 14 engages the release element 13 by the locking portion 143 engaging in the opening 131 in the leg portion 137, the actuation element 14 exerts a torque on the release element 13 via the latching portion 143, which torque is directed in a counterclockwise direction in the sectional view according to FIG. 3 and thus in a direction that additionally reinforces the locking engagement between the locking portion 143 and the opening 131.

When the locking engagement is established, the release portion 130 is elastically deflected and the locking portion 143 slides into the opening 131, and the release portion 130 then returns to its initial position in which the release portion 130 engages the locking portion 143 of the actuation element 14. The release portion 130 is loaded by the locking portion 143 of the actuation element 14 on the run-on element 133 and is pushed in the direction of the actuation element 14 by the resulting torque such that the locking portion 143 moves into complete engagement with the opening 131 in the leg portion 137.

After the locking engagement is released when an electrical wire 2 is inserted, the actuation element 14 moves out of the actuated position due to the elastic preload on the clamping portion 120 and is returned counter to the actuation direction B. The clamping portion 120 comes into clamping abutment with the electrical wire 2 and thereby pushes the conductor end 20 into contacting abutment with the contact element 11 so that the wire 2 is electrically connected to the connection terminal 1 and is also mechanically locked.

Since the actuation element 14 is moved out of the actuated position after the locking engagement is released, a user can safely and reliably detect that the connection terminal 1 has been released and the electrical wire 2 is thus connected to the connection terminal 1. The risk of incorrect operation is thus reduced.

If the electrical wire 2 is to be released from the connected position and re-removed from the connection terminal 1, the actuation element 14 can be transferred back into the actuated position so that the clamping portion 120 is not in abutment with the wire 2. The wire 2 can thus be removed from the connection terminal 1 substantially without any force.

The concept on which the invention is based is not limited to the embodiment described above, but can also be realized in another way.

The release element can, for example, be designed as a sheet metal element. However, other designs of the release element are also conceivable and possible, for example being made of plastic.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1,1A Connection terminal
10 Housing
100 Insertion opening
101 Receiving space
102 Engagement opening
103, 103′ Connecting device
104, 104′ Interlocking element
105, 105′ Housing part
106, 106′ Wall portion
107, 107′ Side wall
11 Contact element (current bar)
110 Contact section
111 Contacting device
12 Clamping spring
120 Clamping portion
121 Supporting portion
122 Intermediate portion
13 Release element
130 Release portion
131 Locking apparatus (locking opening)
132 Supporting end
133 Run-on element
134, 135 Interlocking element (recess)
136 Intermediate portion
137 Leg portion
138 End
14 Actuation element
140 Pivot shaft
141 Actuating portion
142 Through-opening
143 Latching portion
144 Active portion
15 Plug connector portion
3 Connection arrangement
30 Outer housing
A Lined-up direction
B Actuation direction
C Contact point
E Insertion direction

1: A connection terminal for connecting an electrical wire, comprising:
a housing having an insertion opening into which the electrical wire is insertable for connection to the connection terminal;
a contact element arranged on the housing, the contact element being configured to electrically contact the electrical wire;
a spring element arranged on the housing, the spring element having a clamping portion configured to interact with the electrical wire in to bring the electrical wire into contact with the contact element;
an actuation element pivotally arranged on the housing and movable from a non-actuated position into an actuated position so as to move the clamping portion;
a release element having a supporting end and a release portion elastically movable relative to the supporting end; and
a connecting device to which the support end is attached,
wherein the actuation element is configured to engage the release element when in the actuated position so as to hold the actuation element in the actuated position,
wherein the release portion is configured to interact with the electrical wire when the electrical wire is inserted into the insertion opening so as to release the actuation element from the actuated position.

2: The connection terminal of claim 1, wherein the housing defines a receiving space into which the electrical wire is introducible by being inserted into the insertion opening, and
wherein the release portion extends in the receiving space to interact with the electrical wire.

3: The connection terminal of claim 2, wherein the electrical wire is insertable into the insertion opening in an insertion direction,
wherein the release portion extending transversely to the insertion direction within the receiving space.

4: The connection terminal of claim 1, wherein, in a locking position, the release portion is configured to engage the actuation element located in the actuated position and is movable from the locking position by interacting with the electrical wire so as to release the actuation element from the actuated position.

5: The connection terminal of claim 1, wherein the clamping portion is configured to push or pull the electrical wire into abutment with the contact element by spring force.

6: The connection terminal of claim 1, wherein the clamping portion is elastically movable relative to the housing into a release position by actuating the actuation element and is held in the release position relative to the housing by the actuation element locked in the actuated position.

7: The connection terminal of claim 1, wherein the spring element has a supporting portion which is supported on the housing and relative to which the clamping portion is elastically deflectable.

8: The connection terminal of claim 1, wherein the supporting end has at least one first interlocking element,
wherein the connecting device has at least one second interlocking element,
wherein the at least one first interlocking element and the at least one second interlocking element, are configured to interlockingly engage with one another so as to fix the supporting end to the housing.

9: The connection terminal of claim 1, wherein one of the at least one first interlocking element, and the at least one second interlocking element includes a recess, and
wherein an other of the at least one first interlocking element and the at least one second interlocking element includes a projection element, the projection element being configured to interlockingly engage with the recess so as to fix the supporting end to the housing.

10: The connection terminal of claim 1, wherein the actuation element is mounted on the housing so as to be pivotable around a pivot shaft, and
wherein the actuation element has an actuating portion for actuation by a user and an active portion configured to act on the clamping portion.

11: The connection terminal of claim 1, wherein the actuation element has a through-opening through which the spring element passes.

12: The connection terminal of claim 1, wherein the actuation element has a locking portion configured to engage a locking device of the release element when in the actuated position.

13: The connection terminal of claim 12, wherein the locking device includes an opening in the release element, in which the locking portion is configured to engage when the actuation element is in the actuated position.

14: The connection terminal of claim 13, wherein the locking portion is releasable from the opening by deflecting the release portion by interacting with the electrical wire inserted into the insertion opening.

15: A connection arrangement, comprising:
the connection terminal of claim 1; and
a further connection terminal which is arranged adjacently to the connection terminal in a lined-up direction that extends transversely to an insertion direction, in which insertion direction the electrical wire is insertable into the insertion opening,
wherein the housing of the connection terminal comprises two housing parts attached to one another in the lined-up direction.
